(19) United States
(12) Patent Application Publication
(10) Pub. No.: US 2026/0331560 A1
(43) Pub. Date: Oct. 22, 2026

(54) Method for Clamping an Electrode Assembly Into a Housing of a Battery Cell, Battery Cell, Computer Program and Computer Readable Storage Medium

(71) Applicant: Bayerische Motoren Werke Aktiengesellschaft, Muenchen (DE)

(72) Inventors: Alexander ADAM, Muenchen (DE); Franziska Friedrich, Kolbermoor (DE); Nina Zensen, Pfaffenhofen an der llm (DE)

(21) Appl. No.: 19/122,514

(22) PCT Filed: Oct. 23, 2023
(86) PCT No.: PCT/EP2023/079459

§ 371 Date: Apr. 18, 2025

(30) Foreign Application Priority Data
Oct. 27, 2022 (DE) 10 2022 128 442.5

(51) Int. Cl. H01M 10/04; H01M 4/04

(52) U.S. Cl. CPC H01M 10/049; H01M 4/0445

(57) ABSTRACT

An electrode assembly arranged in the housing of the battery cell includes: a first contact foil on a first side of a solid electrolyte, a second contact foil on a second side of the solid electrolyte, and a first electrode layer between the solid electrolyte and the first contact foil. The electrode assembly is charged by applying a first voltage to the contact foils such that ions are deposited from the first electrode layer onto the second contact foil to form a second electrode layer between the second contact foil and the solid electrolyte. A cut-off voltage is set at which the second electrode layer is maintained between the second contact foil and the solid electrolyte in order to set a minimum pressure in the battery cell.

### BACKGROUND AND SUMMARY

The invention relates to a process for securing an electrode assembly in a housing of a battery cell. The invention further relates to a battery cell for performing the process for securing an electrode assembly in a housing of a battery cell. The invention further relates to a computer program for securing an electrode assembly in a housing of a battery cell. The invention further relates to a computer-readable storage medium on which the computer program is stored.

Commonly used motive power batteries for vehicles are conventional batteries having a liquid organic electrolyte. Lithium batteries containing a solid electrolyte offer an advantage over lithium batteries comprising conventional liquid organic electrolytes since the former is non-flammable. Compared to conventional organic electrolytes solid electrolytes exhibit considerably improved safety characteristics since these are not only nonflammable but also reduce lithium dendrite growth. The selectivity of the charge carriers and the high stability of solid electrodes generally also improves not only the cycle stability but also the calendar service life of the battery cell. However, batteries having a solid electrolyte are problematic in that, compared to conventional batteries, the electrode layers and the solid electrolyte must be secured within the battery cell at a high pressure of for example 100 bar to ensure stable and efficient operation of the battery cell.

It is an object of the invention to specify a process for securing an electrode assembly in a housing of a battery cell and to specify a corresponding battery cell, computer program and computer-readable storage medium.

The object is achieved by the subject matter disclosed herein.

At least one embodiment relates to a process for securing an electrode assembly in a housing of a battery cell.

The electrode assembly is, for example, an electrode assembly of a rechargeable battery, especially a solid-state rechargeable battery. The electrode assembly is thus, for example, a single rechargeable storage element for electrical energy. A battery cell especially comprises the electrode assembly employed in a battery housing.

The electrode assembly is arranged in the housing of the battery cell. The electrode assembly comprises a first contact foil, a first electrode layer, a solid electrolyte and a second contact foil, wherein the solid electrolyte comprises a first and a second side. The first contact foil is arranged on the first side of the solid electrolyte and the second contact foil is arranged on the second side of the solid electrolyte. The first electrode layer is arranged between the solid electrolyte and the first contact foil.

The electrode assembly is configured to deposit ions from the first electrode layer onto the second contact foil to form a second electrode layer between the second contact foil and the solid electrolyte by applying a first voltage to the first and the second contact foil to charge the electrode assembly. This is, for example, an electrode assembly of a lithium metal battery cell or an anode-free lithium battery cell.

The electrode assembly is further configured to incorporate ions from the second electrode layer into the first electrode layer by applying a second voltage to the first and the second contact foil to discharge the electrode assembly.

In at least one embodiment the process comprises charging the electrode assembly and forming the second electrode layer via the charging.

The electrode assembly is, for example, arranged in the housing of the battery cell, wherein a cavity is present between the electrode assembly and the housing. Forming the second electrode layer via the charging of the electrode assembly increases the volume of the electrode assembly. The volume of the electrode assembly is for example continuously increased with increasing charge level until the housing of the battery cell is completely filled by the electrode assembly. The housing of the battery cell thus serves as a limit for a further volume increase. Because an increase in the volume due to a further charging of the battery cell is limited by the housing, mechanical forces deriving from the developing second electrode layer are transferred to the electrode assembly and the housing of the battery cell, thus increasing a pressure in the housing of the battery cell. The mechanical forces exerted by the developing second electrode layer and transferred to the electrode assembly and the housing of the battery cell thus depend on the charge level of the battery cell. The charge level of the battery cell represents a cell voltage of the battery cell. In other words, the mechanical forces transferred and thus the pressure inside the housing depend on the cell voltage of the battery cell.

Discharging the battery cell performs the inverse of the described operation. A discharging of the battery cell degrades the second electrode layer of the electrode assembly, thus reducing the volume of the second electrode layer and thus the volume of the electrode assembly and the mechanical forces transferred from the second electrode layer, thus reducing the pressure in the housing of the battery cell.

At least one embodiment comprises specifying a discharging end point voltage at which the second electrode layer at is at least partially retained between the second contact foil and the solid electrolyte to establish a minimum pressure in the battery cell. The partially retained second electrode layer for example encompasses a predetermined thickness.

The specifying of the discharging end point voltage terminates the discharging of the battery cell upon achieving the discharging end point voltage. Achieving a discharging end point voltage is regarded for example as a discharged state of the battery cell. The second electrode layer at least partially arranged between the second contact foil and the solid electrolyte is thus advantageously not entirely degraded and even in the discharged state exerts pressure on the electrode assembly and the housing of the battery cell via the transferred mechanical forces.

Upon achieving the discharging end point voltage, the second electrode layer exerts for example a minimum pressure of 50 bar, 80 bar or 100 bar on the electrode assembly and the housing of the battery cell to secure the electrode assembly in the housing of the battery cell.

The process advantageously utilizes an available space more efficiently since no further apparatuses, for example springs, are required to secure the electrode assembly. The energy density in the available space is thus increased, for example.

In one embodiment the discharging end point voltage is determined according to a pressure to be expected in the housing of the battery cell.

The relationship between the discharging end point voltage and the pressure in the housing of the battery cell ensures that a sufficient pressure for securing the electrode assembly in the housing of the battery cell is present. This ensures efficient operation of the battery cell.

The relationship between the discharging end point voltage and the pressure in the housing of the battery cell makes it possible for example to adapt the discharging end point voltage if for example possible requirements of the pressure for securing the electrode assembly change due to aging effects on the electrode assembly.

In at least one embodiment, the pressure in the housing of the battery cell depends on a cell chemistry of the electrode materials of the electrode assembly and/or the volume between the electrode assembly and the housing of the battery cell and/or a lithium content of the first electrode material.

The cell chemistry of the electrode materials of the electrode assembly can cause the optimal pressure for the operation of the battery cell to vary, thus resulting in the electrode assembly being secured in the housing of the battery cell with a higher or lower pressure.

The pressure in the housing of the battery cell depends, for example, on a mass loading and/or a capacity loading of the electrode assembly.

Alternatively, or in addition, the pressure in the battery cell may depend on the size of the cavity between the electrode assembly and the housing of the battery cell. Alternatively, or in addition, the pressure in the housing of the battery cell depends on the lithium content of the first electrode material since the thickness of the electrode layer formed increases the more lithium from the first electrode material is deposited on the first contact foil or the already formed electrode layer.

In at least one embodiment, the electrode assembly is mechanically coupled to the housing of the battery cell.

The mechanical coupling of the electrode assembly to the housing of the battery cell transfers the mechanical forces exerted by the second electrode layer on the housing of the battery cell.

In at least one embodiment, the housing of the battery cell is in the form of a cylindrical cell (round cell).

A cylindrical battery cell format has known advantages, for example a high energy density. Conventional solid-state battery cells have hitherto typically been employed in a pouch cell format since securing apparatuses are utilized to apply the required pressure for securing the electrode assembly in the housing of the battery cell. Due to the construction of a round cell an apparatus for securing the electrode assembly appears to be inefficient.

The securing of the electrode assembly via a volume change and the increase in pressure due to the mechanical forces of the developing second electrode layer has the result that securing apparatuses are no longer necessary, thus making it possible to use the cylindrical cell format.

At least one embodiment includes a battery cell with which the process for securing an electrode assembly in a housing of a battery cell may be performed.

At least one embodiment further provides a computer program for securing an electrode assembly in a housing of a battery cell comprising commands which upon execution of the computer program by a computer cause the computer to perform the process for securing an electrode assembly in a housing of a battery cell.

At least one embodiment further provides a computer-readable storage medium on which the computer program is stored.

The computer-readable storage medium especially comprises a medium readable by a data processing apparatus on which program code is stored.

Exemplary embodiments of the invention are described with reference to the schematic diagrams.

### BRIEF DESCRIPTION OF THE DRAWINGS

FIG. 1 shows a flow diagram of a program for securing an electrode assembly in a housing of a battery cell in accordance with at least one embodiment;

FIG. 2 shows an electrode assembly in a housing of a battery cell in accordance with at least one embodiment;

FIG. 3 shows an electrode assembly in a housing of a battery cell in accordance with at least one embodiment;

FIG. 4 shows an electrode assembly in a housing of a battery cell in accordance with at least one embodiment.

### DETAILED DESCRIPTION OF THE DRAWINGS

Elements of identical construction or function are labelled with identical reference numerals throughout the figures.

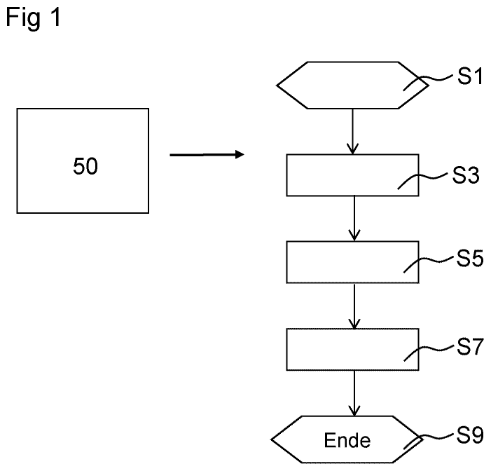

FIG. 1 shows a flow diagram of a program for securing an electrode assembly in a housing of a battery cell.

An apparatus 50 is configured for executing the program. To this end, the apparatus 50 especially comprises a processing unit, a program and data storage means and for example one or more communication interfaces. The program and data storage means and/or the processing unit and/or the communication interfaces may be configured in one unit and/or distributed over a plurality of units.

The apparatus 50 may also be described as an apparatus for securing an electrode assembly in a housing of a battery cell.

The program and data storage means of the apparatus 50 especially has the program stored on it.

The program is started in a step S1 in which variables may optionally be initialized.

In a step S3 the electrode assembly 20 is charged.

The electrode assembly 20 is for example a lithium metal electrode assembly.

The electrode assembly 20 is charged for example as soon as a first voltage is applied to the first and the second contact foil 21, 25. During charging the electrode assembly 20 for example deposits lithium ions from the first electrode layer 21 onto the second contact foil 25 to form a second electrode layer 24, a lithium metal electrode layer, between the second contact foil 25 and the solid electrolyte 23.

During discharging a second voltage is likewise applied to the first and the second contact foil 21, 25, wherein the polarity of the second voltage is distinct from that of the first voltage. The discharging of the electrode assembly 20 causes lithium ions from the second electrode layer 24 to be incorporated into the first electrode layer 21. The second electrode layer 24 is thus degraded.

The electrode assembly 20 is for example fully charged over a whole capacity range.

In a step S5 a discharging end point voltage is specified.

The specifying of the discharging end point voltage ensures that the electrode assembly 20 is not discharged below the discharging end point voltage.

The discharging end point voltage is for example specified according to a pressure in the housing 10 of the battery cell and/or an aging condition of the battery cell. The discharging voltage varies linearly with the pressure in the housing 10 of the battery for example. For example, the pressure in the housing 10 increases with increasing discharging end point voltage.

The discharging end point voltage is for example specified to prevent the second electrode layer 24 from being completely degraded during discharging.

In the case of advanced aging of the battery cell for example an available capacity is reduced, whereupon the discharging end point voltage is reduced with increasing aging condition according to the aging condition of the battery cell in order to obtain additional lithium from the second electrode layer 24 to counter the aging of the battery cell and the reduction in available capacity. In an optional step S7 the electrode assembly 20 is discharged.

The electrode assembly 20 is discharged for example down to the specified discharging end point voltage. This has the result for example that a total available capacity of the electrode assembly 20 is not utilized. For example, 10% of the available capacity remains in the second electrode layer 24 in order not to completely degrade the second electrode layer 24. The discharging end point voltage thus serves for example as a limit on a discharging to maintain the pressure inside the battery cell such that the electrode assembly is secured inside the housing of the battery cell.

In a step S9, the program is terminated and may optionally be restarted.

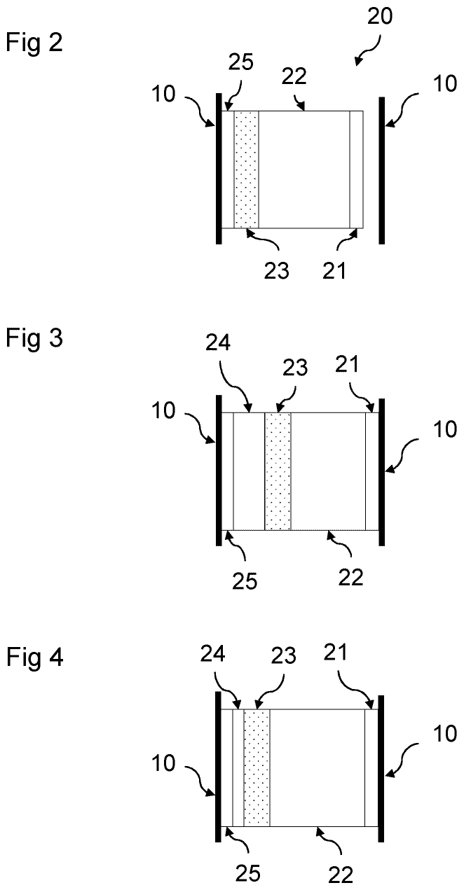

FIG. 2 shows a first exemplary embodiment of an electrode assembly 20 in a housing of a battery cell.

FIG. 2 shows an electrode assembly 20 comprising a first contact foil 21, a first electrode layer 22, a solid electrolyte 23 and a second contact foil 25 arranged in a housing 10 of a battery cell.

Arranged between the first contact foil 21 and the housing 10 is a cavity since the electrode assembly 20 has been placed in the housing 10 of the battery cell but is not yet secured in the housing 10 of the battery cell.

FIG. 3 shows a second exemplary embodiment of an electrode assembly 20 in a housing 10 of a battery cell. FIG. 3 shows a fully charged state of the electrode assembly 20.

In addition to the components of the electrode assembly 20 from FIG. 2, FIG. 3 shows the second electrode layer 24 formed by the charging of the electrode assembly 20.

FIG. 3 likewise elucidates that the cavity is filled by the increase in volume of the electrode assembly 20.

FIG. 4 shows a third exemplary embodiment of an electrode assembly 20 in a housing 10 of a battery cell.

FIG. 4 shows the electrode assembly 20 after a discharging operation down to the specified discharging end point voltage. The second electrode layer 24 is shown with a reduced thickness compared to the fully charged state from FIG. 3.

### LIST OF REFERENCE NUMERALS

| S1-S9 | Steps |
|---|---|
| 10 | Housing |
| 20 | Electrode assembly |
| 21 | First contact foil |
| 22 | First electrode layer |
| 23 | Solid electrolyte |
| 24 | Second electrode layer |
| 25 | Second contact foil |
| 50 | Apparatus |

1-9. (canceled)

10. A process for securing an electrode assembly in a housing of a battery cell, wherein the electrode assembly is arranged in the housing, wherein the electrode assembly comprises: a first contact foil, a first electrode layer, a solid electrolyte and a second contact foil, wherein the solid electrolyte comprises a first and a second side, wherein the first contact foil is arranged on the first side and the second contact foil is arranged on the second side of the solid electrolyte, wherein the first electrode layer is arranged between the solid electrolyte and the first contact foil, wherein the electrode assembly is configured to deposit ions from the first electrode layer onto the second contact foil to form a second electrode layer between the second contact foil and the solid electrolyte by applying a first voltage to the first contact foil and the second contact foil to charge the electrode assembly, wherein the electrode assembly is further configured to incorporate ions from the second electrode layer into the first electrode layer by applying a second voltage to the first contact foil and the second contact foil to discharge the electrode assembly, the process comprising:
charging the electrode assembly and forming the second electrode layer via the charging,
specifying a discharging end point voltage at which the second electrode layer is at least partially retained between the second contact foil and the solid electrolyte to establish a minimum pressure in the battery cell.

11. The process of claim 10, wherein the discharging end point voltage is specified according to a pressure to be expected in the housing of the battery.

12. The process of claim 10, wherein the pressure in the housing of the battery cell depends on a cell chemistry of the electrode materials of the electrode assembly and/or the volume between the electrode assembly and the housing of the battery cell and/or a lithium content of the first electrode material.

13. The process of claim 10, wherein the electrode assembly is mechanically coupled to the housing of the battery cell.

14. The process of claim 10, wherein the housing of the battery cell is configured as a round cell.

15. A non-transitory computer-readable medium storing instructions thereon that when executed by a computing device cause the computing device to perform the process of claim 10.
